(19) United States
(12) Patent Application Publication
(10) Pub. No.: US 2024/0208154 A1
(43) Pub. Date: Jun. 27, 2024

(54) CONTINUOUS 3D PRINTING WITH CONVEYOR BELT

(71) Applicant: International Business Machines Corporation, Armonk, NY (US)

(72) Inventors: Mauro MARZORATI, Lutz, FL (US); Faith OPIYO, Nieuw Vennep (NL); Jeremy R. FOX, Georgetown, TX (US); Vinod A. VALECHA, Pune (IN)

(21) Appl. No.: 18/145,624

(22) Filed: Dec. 22, 2022

(51) Int. Cl. B29C 64/40; B29C 64/176; B29C 64/236; B29C 64/245; B29C 64/321; B29C 64/35; B29C 64/393; B33Y 10/00; B33Y 30/00; B33Y 40/20; B33Y 50/02; B65G 47/90

(52) U.S. Cl. CPC B29C 64/40; B29C 64/176; B29C 64/236; B29C 64/245; B29C 64/321; B29C 64/35; B29C 64/393; B33Y 10/00; B33Y 30/00; B33Y 40/20; B33Y 50/02; B65G 47/905

(57) ABSTRACT

A disclosed system and methods provide enhanced, continuous 3D printing to manufacture 3D objects utilizing stabilizers supporting a 3D object being printed in components along a conveyor belt, enabling enhanced, efficient and effective manufacturing of 3D objects. A selected 3D object is printed from a primary material on supporting stabilizers, and the stabilizers are printed from a secondary material. The system coordinates movement of the printer head along the printing plane and the conveyor belt, creating an elongated printing surface along the conveyor belt for continuous 3D printing. Upon completion, the 3D object with the supporting stabilizers exits the conveyor belt and the 3D object is removed from the stabilizers.

### BACKGROUND

The present invention relates to three-dimensional (3D) printing, and more specifically, to a system and methods for implementing continuous 3D printing for manufacturing 3D objects.

Besides casting and molding, two types of parts' manufacturing techniques include additive manufacturing where material is deposited in successive layers and subtractive manufacturing where material is removed from a solid block. 3D printing or additive manufacturing is a process of making three-dimensional solid objects from a digital file. The creation of a 3D printed object is achieved using additive processes. In an additive printing process, an object is created by laying down successive layers of material until the object is created. 3D printing is the opposite of subtractive manufacturing which is cutting out or hollowing out a piece of metal or plastic with for instance a milling machine. 3D printing can enable production of complex shapes using less material than traditional manufacturing methods.

Many 3D printing systems or 3D printers include a build plate (i.e., a heated bed or print bed) providing a surface of the 3D printer on which the 3D printed object is formed. The build plate keeps the base of the build object warm to prevent the 3D object from cooling unevenly and warping as a result. Two types of batch-loaded ovens include one where a batch to be baked or heat-treated is placed inside a heating chamber and then removed after the cycle completes, and another continuous oven where the object enters and exits the chamber while transported by a conveyor mechanism. Current 3D printing typically is done in batches, where the 3D printer is reset, for example with resetting the position of the build plate between producing 3D objects.

Problems with some existing 3D printers include the time that is lost during a reset process to move the build plate and another is the limit of an overall size of 3D object being manufactured due to the available size of the printing chamber.

A need exists for new techniques and a system for implementing continuous 3D printing to manufacture 3D objects, enabling enhanced, efficient and effective manufacturing of 3D objects.

### SUMMARY

Embodiments of the disclosure are directed to a system and methods for enhanced continuous 3D printing to manufacture 3D objects utilizing stabilizers supporting a 3D object being printed along a conveyor belt, enabling enhanced, efficient and effective manufacturing of 3D objects.

A non-limiting computer-implemented method comprises selecting a 3D object to be printed in components along a conveyor belt; the 3D object is formed of a primary material. Before printing a first component of the object, a first supporting stabilizer is printed from a secondary material and the first stabilizer has a shape based on the first component. The first component is printed on the first supporting stabilizer. Before printing a second component of the object, a second supporting stabilizer connected to the first supporting stabilizer is printed from the secondary material and the second supporting stabilizer has a shape based on the second component. The second component is printed on the second supporting stabilizer. After printing all components of the 3D object, a connecting stabilizer connected to the supporting stabilizers is printed from the secondary material. The 3D object with the supporting stabilizers exit the conveyor belt and the connecting stabilizer is cut. The 3D object is removed from the stabilizers.

Other disclosed embodiments include a computer control system and computer program product for implementing continuous 3D printing to manufacture 3D objects implementing features of the above-disclosed method.

### BRIEF DESCRIPTION OF THE DRAWINGS

FIG. 1 is a block diagram of an example computer environment for use in conjunction with one or more disclosed embodiments for implementing 3D printing to manufacture 3D objects;

FIG. 2 is a block diagram of an example system for implementing 3D printing to manufacture 3D objects of one or more disclosed embodiments;

FIG. 3 schematically illustrates an example 3D printer assembly to be positioned for use in the system of FIG. 2 for performing continuous 3D printing of one or more disclosed embodiments;

FIG. 4 schematically illustrates an example conveyor belt assembly for use in the system of FIG. 2 for performing continuous 3D printing of one or more disclosed embodiments;

FIG. 5 schematically illustrates an example assembly of the 3D printer of FIG. 3 mounted on the conveyor belt assembly of FIG. 4;

FIG. 6 schematically illustrates details of an assembly of the 3D printer of FIG. 3 and the conveyor belt assembly of FIG. 4 for performing continuous 3D printing of one or more disclosed embodiments;

FIG. 7 is a flow chart illustrating example system operations of a method for performing continuous 3D printing of one or more disclosed embodiments; and

FIG. 8 is a flow chart illustrating further example system operations of a method for performing continuous 3D printing of one or more disclosed embodiments.

### DETAILED DESCRIPTION

Embodiments of the disclosure provide a system and methods for enhanced continuous 3D printing to manufacture 3D objects utilizing stabilizers supporting a 3D object being printed along a conveyor belt, enabling enhanced, efficient and effective manufacturing of 3D objects.

A disclosed non-limiting method comprises selecting a 3D object to be printed in components along a conveyor belt from a primary material. Before printing a first component of the object, an initial or first stabilizer is printed from a secondary material and the first stabilizer has a shape based on the first component. For example, the stabilizer shape can be printed in a general pyramidal fashion that achieves internal stability by successive laying down layers of the secondary material as a print head moves along the printing plane with movement of the conveyor belt. This process continues until the first stabilizer reaches a set dimension based on the shape of the first component to be printed.

The first component (e.g., a portion of the desired 3D object) is printed on the first stabilizer. For example, the printing of the first component begins by laying down successive layers of the primary material on the first stabilizer as the print head moves along the printing plane with movement of the conveyor belt. Before printing a second component of the object (e.g., another portion of the desired 3D object), a second stabilizer is printed from the secondary material connected to the first stabilizer and the second stabilizer has a shape based on a second component. The second component is printed on the second stabilizer. Upon completion of the printing the object's components, a connecting stabilizer is printed from the secondary material. For example, the connecting stabilizer may be relatively weak by virtue of its sharp angles and shallowness. In a disclosed embodiment, after the printed 3D object with the supporting stabilizers exit the conveyor belt, a cutting mechanism cuts the connecting stabilizer to separate the completed 3D object with its stabilizers from a next or successive 3D object to be manufactured. The printed object and supporting stabilizers are processed to remove the stabilizers from the 3D printed object, for example in any manner that is compatible with a specific secondary material forming the stabilizers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Print Head and Conveyor Belt Control Logic 182, Printing Control Logic 184, and Robotic Hand Control Logic 186 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

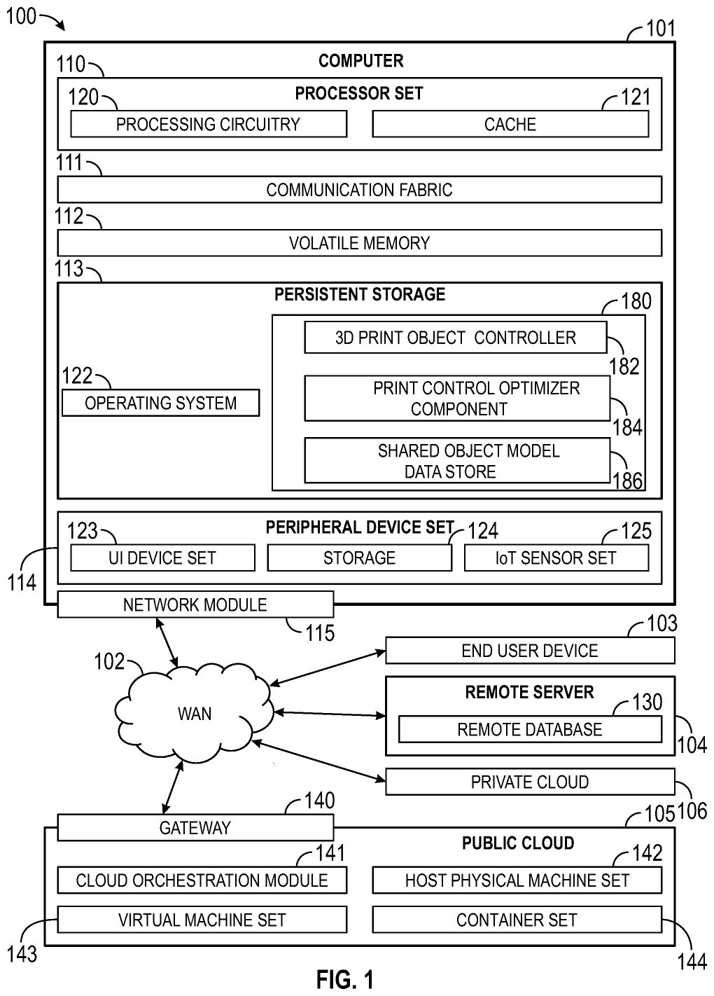

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

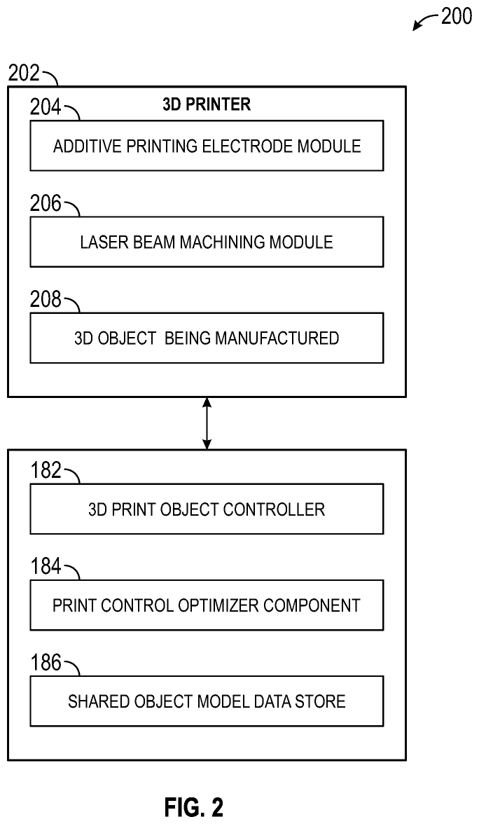

FIG. 2 illustrates an example system 200 for implementing 3D printing to manufacture 3D objects of one or more disclosed embodiments. System 200 includes the Print Head and Conveyor Belt Control Logic 182, the Printing Control Logic 184 and Robotic Hand Control Logic 186 that can be used in conjunction with the computer 101 of the cloud computing environment 100 of FIG. 1 for implementing 3D printing for manufacturing 3D objects of disclosed embodiments.

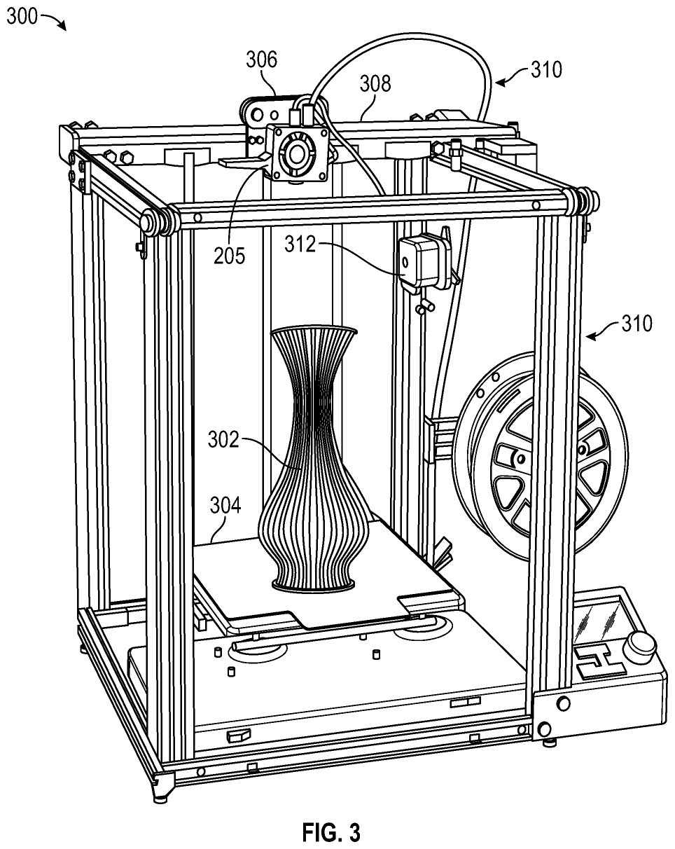

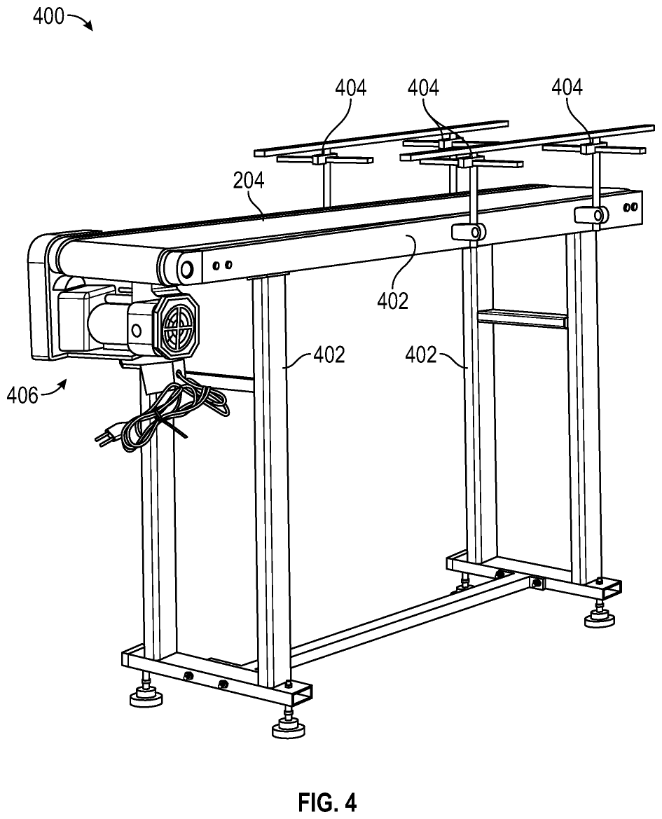

System 200 includes a 3D printer 202, which can implement any type of 3D printing technologies, such as dual material, multi-print head, multiple print nozzles, multiple filaments, and the like. 3D printer 202 includes a conveyor belt 204 such as illustrated in FIGS. 4, 5 and 6, and one or more print heads 205 such as illustrated in FIGS. 3, 5, and 6. System 200 coordinates movement of the printer head 205 along the printing plane (e.g., printing Y axis and Z axis of printer head movement) and movement of the conveyor belt 204 to create an elongated printing surface along a horizontal axis (X-axis) of the conveyor belt 204 for continuous 3D printing of disclosed embodiments to manufacture 3D objects.

System 200 includes a robotic hand 208 for maintaining available printing material supplies for continuous printing, and for removing completed 3D objects with the associated stabilizers from the 3D printer 202. System 200 includes weight sensors 208 for monitoring weight of a primary material and a secondary material relative to set threshold values. System 200 triggers the robotic hand 206 to replenish the supply of an identified primary material or secondary material below the set threshold value. System 200 includes a decontaminator 210 operatively controlled to clean any materials and debris from the conveyor belt 204 after the completion of printing the 3D object 302.

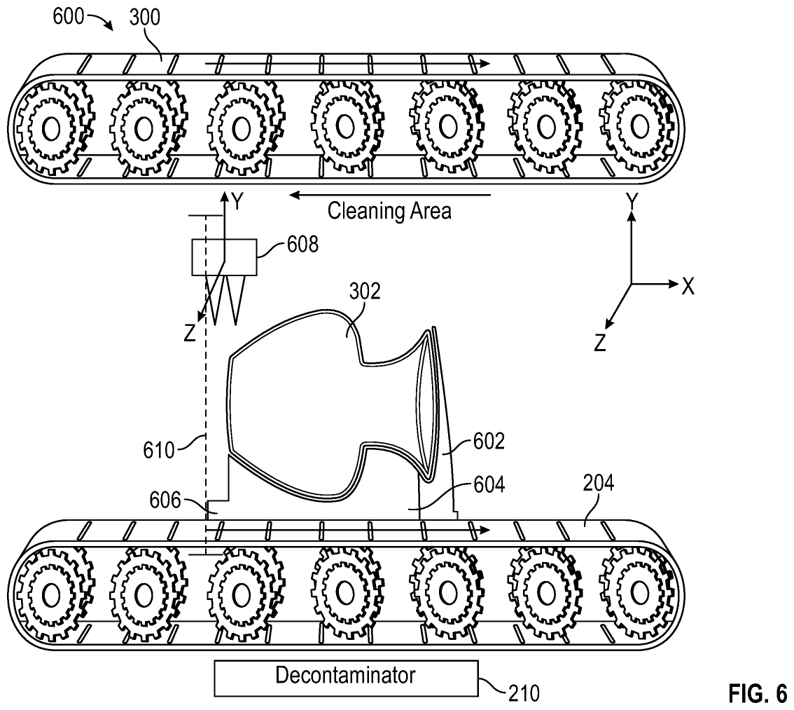

System 200 with the Print Head and Conveyor Belt Control Logic 182 coordinates and controls movement of the conveyor belt 204 with the print heads 205. System 200 with the Printing Control Logic 184 controls printing of a primary material of an object being manufactured, such as object 302 in FIGS. 3-6 and a secondary material of stabilizers, such as stabilizers 602, 604 and 606 in FIG. 6. System 200 with the Robotic Hand Control Logic 186 controls the robotic hand 207 to replace or refill a respective printing material supply including the primary material and the secondary material, and for example, to remove a completed 3D object with the stabilizers from the conveyor belt 204.

FIG. 3 schematically illustrates an example 3D printer assembly 300, for example that can be configured and positioned to implement the 3D printer 202 of system 200 for perform continuous 3D printing of disclosed embodiments. In FIG. 3, an example 3D object 302 in the form of a vase to be manufactured with 3D printer 202 of system 200. In the illustrated orientation of the 3D printer 202, the example 3D object 302 is formed on a build plate 304, which provides the surface on which the 3D printed object 302 is vertically formed.

In the illustrated printer orientation shown in FIG. 3, the 3D object 302 is built upwardly from the build plate surface 304, layer by layer from the bottom to the top of the 3D object.

In system 200, a selected orientation of the 3D printer 202 is provided to enable printing an object 302 with supporting stabilizers along the conveyor belt 204 in a horizontal plane, rather than on the illustrated build plate 304. In system 200, 3D printer 202 can include a print head assembly, such as the illustrated print head assembly 306 including one or more printer heads 205. In system 200, 3D printer 202 can include a print head movement assembly 308 and a print material supply assembly 310. 3D printer 202 can include a video monitoring system 312, for example including one or more cameras including existing 3D printing technology for providing capability to identify defects in 3D objects 302, enabling system 200 to correct such identified defects. The 3D printer 202 can be mounted on an example conveyor belt assembly 400 as illustrated in FIG. 4. In system 200, 3D printer 202 includes a print head assembly 306 including one or more printer heads 205, a print head movement assembly 308 and a print material supply assembly 310. 3D printer 202 includes a video monitoring system 312, for example including one or more cameras including existing 3D printing technology for providing capability to identify defects in 3D objects 302, enabling system 200 to correct such identified defects.

FIG. 4 schematically illustrates the example conveyor belt assembly 400 for supporting the 3D printer 202 in system 200 for performing continuous 3D printing of disclosed embodiments. Conveyor belt assembly 400 includes a vertical support assembly 402 carrying the conveyor belt 204 and including tool-mounting features 404, for example used to mount and support the 3D printer 202. Conveyor belt assembly 300 includes a drive assembly 406 for moving the conveyor belt 204, for example controlled by system 200 with the Print Head and Conveyor Belt Control Logic 182.

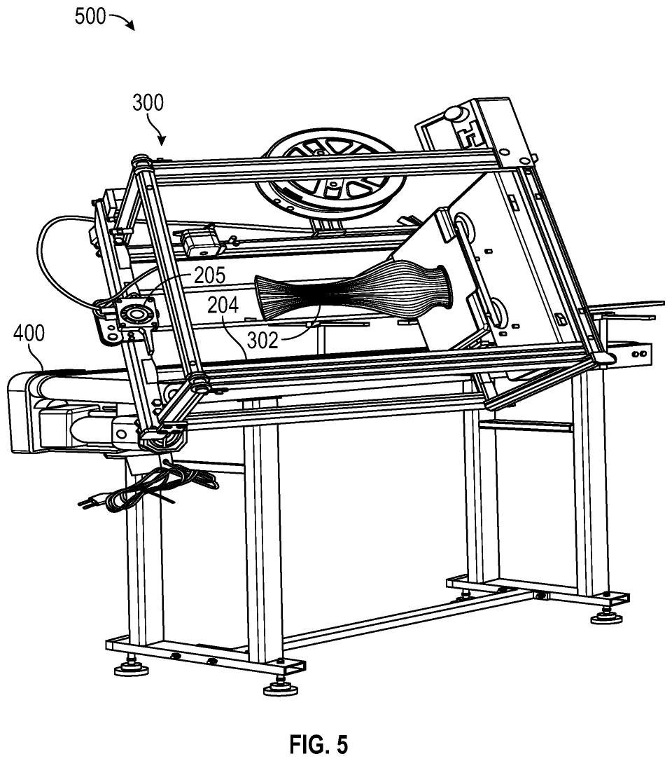

Referring to FIG. 5, an example assembly 500 illustrates the 3D printer assembly 300 of FIG. 3 mounted on the conveyor belt assembly 400 of FIG. 4. An example assembly 600 shown in FIG. 6 illustrates the 3D printer assembly 300 with the conveyor belt assembly 400 for implementing the 3D printer 202 and conveyor belt 204 of system 200 for performing continuous 3D printing of one or more disclosed embodiments. The assembly 500 shows a generally sideways orientation of the 3D printer 202 mounted on the conveyor belt assembly 400 for an alternative configuration to the vertical printing of FIG. 3.

In one disclosed embodiment, the 3D horizontal printing along a horizontal axis of the conveyor belt 204 enables enhanced continuous printing of longer 3D objects formed of a primary material, by printing the object and stabilizers formed of a secondary material supporting the 3D object being printed on the conveyor belt 204. The 3D horizontal printing of disclosed embodiments may be understood having reference to an illustrated assembly 600 in FIG. 6.

FIG. 6 schematically illustrates an assembly 600 of components of the 3D printer assembly 300 and the conveyor belt assembly 400 used for performing continuous 3D printing of disclosed embodiments. A continuous printing operation includes the controlled movement of the conveyor belt 204 along the horizontal axis (X-axis) with movement of the print axis of the print head 205 along a Y-axis and Z-axis.

System 200 enables effective 3D printing with the combined, coordinated movement of the conveyor belt 204 and the one or more printer heads 205. System 200 with the Print Head and Conveyor Belt Control Logic 182 coordinates and controls movement of the print heads and conveyor belt 204 for printing a selected 3D object, such as the illustrated object 302 with a selected orientation.

Assembly 600 shows the 3D object 302 supported and printed on an initial stabilizer 602 printed on the conveyor belt 204 that is connected to an ongoing stabilizer 604, which is connected to a connecting stabilizer 606. The connecting stabilizer 606 is printed after the completion of printing the 3D object 302 in its entirety. Assembly 600 schematically illustrates a print head module 608 including print heads 205. For example, the print head module 608 includes multiple print nozzles or print heads 205 illustrated by cones below the print head module. Separate print heads 205 enable printing dual materials including a primary material for the 3D object 302 and a secondary material for the stabilizers 602, 604 and 606. A printing plane 610 indicated by a dashed line between the print head module 608 and the conveyor belt 204 illustrates a starting position for 3D printing. For example, the printing of the illustrated stabilizer 602 on the conveyor belt 204 started proximate the printing plane 610. The illustrated position of the stabilizer 602 on the conveyor belt 204 in FIG. 6 follows printing of the entire 3D object 302. The conveyor belt 204 runs in a horizontal plane both in a forward direction and in reverse direction. For example, the conveyor belt 204 can run in the forward direction such as for normal print processing and in the reverse direction for rework or defect correction print processing. As shown, a decontaminator 210 positioned near an underside of the conveyor belt 204 is activated to clean debris from the conveyor belt 204 after the completion of printing the 3D object 302.

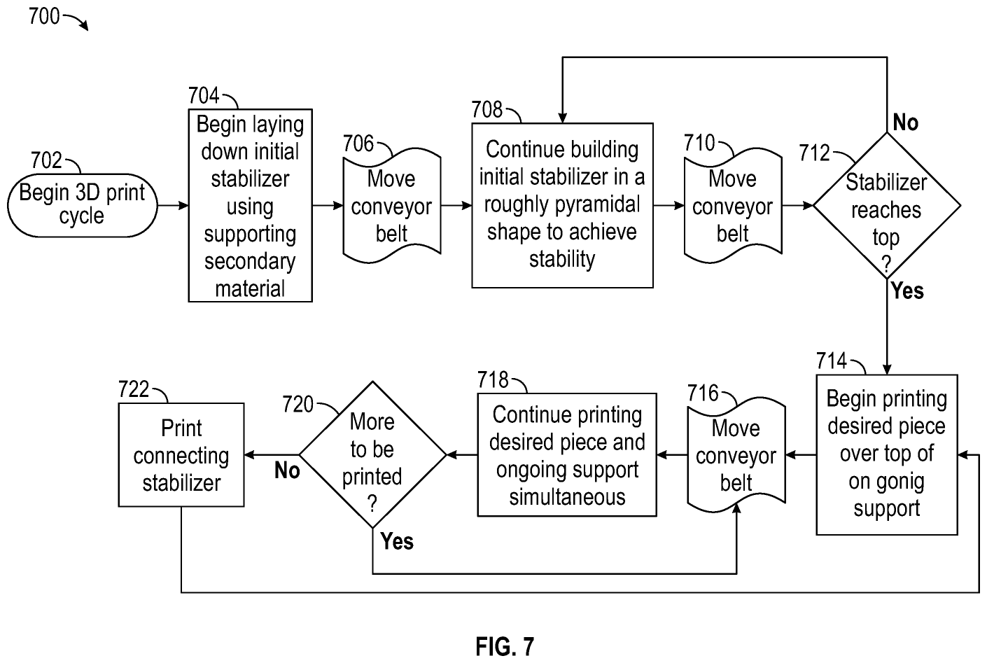

FIG. 7 illustrates example system operations of a method 700 implemented by system 200 and Print Head and Conveyor Belt Control Logic 182, Printing Control Logic 184 for enhanced, continuous 3D printing to manufacture 3D objects of one or more disclosed embodiments. System 200 prints a selected 3D object 302 in components along the conveyor belt 204 from a primary material in a 3D print cycle of method 700, such as shown in the assembly 600 of FIG. 6. System 200 prints supporting stabilizers 602, 604, 606 from a secondary material and prints the components (e.g., portions of the selected 3D object) of the selected 3D object 302 onto the supporting stabilizers, removing the 3D object from the stabilizers when all the components of the 3D object have been printed.

At block 702, the 3D print cycle begins. At block 704, system 200 starts printing an initial or first stabilizer 602 from a secondary material, the printed first stabilizer has a shape based on a shape of the first component (i.e., portion of 3D object 302.) System 200 moves the conveyor belt 204 in a forward or left to right horizontal direction such as shown in FIG. 6, as indicated at block 706. As indicated at block 708, system 200 continues printing, building the first stabilizer 602 in a general pyramidal shape to achieve internal stability by successively laying down layers of the secondary material as the print head 608 moves along the printing plane 610 together with movement of the conveyor belt 204 at block 710. This process continues, for example until the first stabilizer 602 is as tall as the desired shape is to be printed, identified at decision block 710. At block 714, system 200 starts printing the selected 3D object 302 in components on the conveyor belt 204, starting with a first component (i.e., portion of 3D object above stabilizer 602) of the defined shape, for example by laying down layers of an ongoing supporting stabilizer 602 of the secondary material and the first component from the primary material, layer by layer along the printing plane 610. At block 716, system 200 moves the conveyor belt 204 and at block 718 system 200 continues printing of each component or 3D object portions and the ongoing supporting stabilizer 604 until all the components of the 3D object 302 are printed. At decision block 720, system 200 checks whether more printing is required. If yes, system 200 returns to block 716 to move the conveyor belt 204 and continue printing all components of the 3D object 302 at block 718. At block 722, system 200 prints a connecting stabilizer 606 after identifying the completion of each of the components for the 3D object 302 in its entirety.

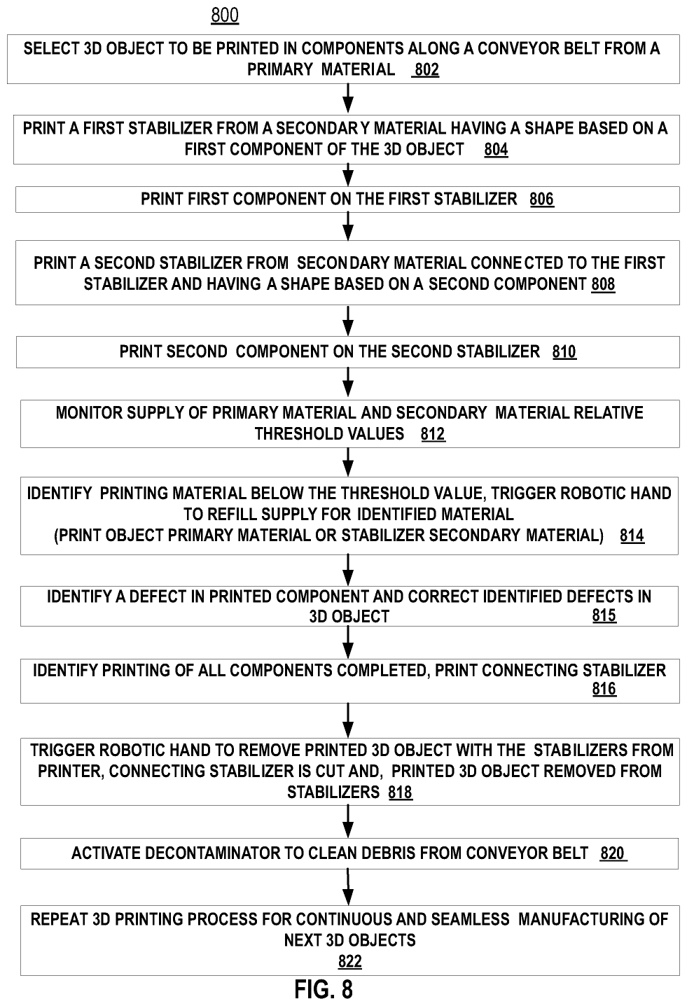

FIG. 8 illustrates further example system operations of a method 800 implemented by system 200 and Print Head and Conveyor Belt Control Logic 182, Printing Control Logic 184, and Robotic Hand Control Logic 186 used together for enhanced, continuous 3D printing to manufacture 3D objects of one or more disclosed embodiments. Referring also to FIG. 6 as indicated at block 802, system 200 selects a 3D object 302 to be printed in components along a conveyor belt 204 from a primary material. At block 804, system 200 prints a first stabilizer 602 from a secondary material based on a shape of a first component, i.e., printing the first stabilizer 602 begins before printing the first component of the 3D object. At block 806, system 200 prints the first component of the 3D object on the first stabilizer 602. At block 808, system 200 prints a second stabilizer 604 from a secondary material connected to the first stabilizer 602 and having a shape based on a shape of a first component of the 3D object. At block 810, system 200 prints the second component on the second stabilizer 604. System 200 repeats printing operations at blocks 808 and 810 for each of the components of the 3D object 302 to be printed creating an ongoing stabilizer 604 for multiple components of the 3D object. For example, system 200 can print the ongoing stabilizer and the sequential components simultaneously, sequentially or a combination thereof.

At block 812, system 200 monitors the supply of primary and secondary printing materials relative to set threshold values during each printing cycle. During the 3D object print cycle to allow for continuous printing, printing materials used are supplied to the 3D printer 202 to enable continuous printing. In one disclosed embodiment, the robotic hand 206 associated with the 3D printer 202 is able to provide material refills without stopping production. In one embodiment, weight sensors 208 can monitor the amount of primary and secondary printing materials remaining for printing, for example, by monitoring weight of the printing materials. At block 814, when system 200 identifies a supply of a primary or secondary printing material below the set threshold value, system 200 triggers the robotic hand 206 to refill the supply of the identified material without interrupting the printing cycle.

At block 815, system 200 identifies a defect in the 3D object 302 and corrects any identified defects in the 3D object. For example, a defect can be identified by the 3D printer 202 using available printer capability, such as video monitoring system 312 illustrated in FIG. 3. At block 815, system 200 moves and positions the 3D object controlling movement of the conveyor belt 204 and the print head 608, and controls printing for defect correction or rework processing with the Print Head and Conveyor Belt Control Logic 182 and the Printing Control Logic 184. At block 816, system 200 identifies all components printed, and prints a connecting stabilizer. System 200 prints the connecting stabilizer, such as the illustrated connecting stabilizer 606 in FIG. 6, for example that is easily cut after removing the completed 3D object from the 3D printer 202.

At block 818, system 200 can trigger the robotic hand 206, or another mechanism to remove the completed 3D object 302 with the supporting stabilizer 602, 604, 606 from the printer 202. At block 818 in one embodiment a cutting mechanism is activated to cut the connecting stabilizer 606; and the completed 3D object 302 is removed the supporting stabilizer 602, 604, 606. At block 820, system 200 activates a decontaminator or other cleaning apparatus to clean debris from the conveyor belt 204. In one embodiment, an underside of the conveyor belt 204 is fitted with cleaning apparatus or decontaminator 210, such as illustrated in FIG. 6. At block 820, the decontaminator 210 performs cleaning of debris to avoid contamination of a next object to be printed by any debris or left over material.

At block 822, system 200 can repeat the 3D printing process enabling continuous and seamless manufacturing of next 3D objects. System 200 enables enhanced, continuous 3D printing to manufacture 3D objects utilizing the 204 conveyor belt supporting the 3D object being printed, enabling enhanced, efficient and effective manufacturing of 3D objects, where the size of the 3D objects is not limited by a chamber size of conventional 3D printers.

While the foregoing is directed to embodiments of the present invention, other and further embodiments of the invention may be devised without departing from the basic scope thereof, and the scope thereof is determined by the claims that follow.

What is claimed is:

1. A method comprising:
selecting a 3D object to be printed in components along a conveyor belt from a primary material;
printing a first stabilizer from a secondary material having a shape based on a first component of the 3D object;
printing the first component on the first stabilizer;
printing a second stabilizer from the secondary material connected to the first stabilizer having a shape based on a second component of the 3D object;
printing the second component on the second stabilizer;
identifying completion of printing all the components of the 3D object; and
removing the 3D object with the stabilizers from the conveyor belt.

2. The method of claim 1, further comprising:
removing the 3D object from the stabilizers following removal of the 3D object and the stabilizers from the conveyor belt.

3. The method of claim 1, wherein identifying completion of printing all the components of the 3D object further comprises printing a connecting stabilizer from the secondary material connected to the stabilizers, and wherein the connecting stabilizer is cut to separate the removed 3D object from a next 3D object to be printed.

4. The method of claim 1, wherein identifying completion of printing all the components of the 3D object further comprises cleaning the conveyor belt with a decontaminator positioned under the conveyor belt.

5. The method of claim 1, wherein removing the 3D object with the stabilizers from the conveyor belt further comprises providing a robotic hand, and controlling the robotic hand to remove the 3D object with the stabilizers from the conveyor belt.

6. The method of claim 1, wherein identifying completion of printing all the components of the 3D object further comprises identifying a defect and correcting the defect before removing the 3D object with the stabilizers from the conveyor belt.

7. The method of claim 1, further comprising:
providing sensors for monitoring a threshold supply level of both the primary material and the secondary material, and providing material refill for the identified primary material or the secondary material below the threshold level.

8. The method of claim 7, further comprising:
providing a robotic hand, and controlling the robotic hand to provide material refill for the identified primary material or the secondary material below the threshold level.

9. The method of claim 1, further comprising:
enabling bidirectional movement of the conveyor belt, controlling movement of the conveyor belt in a forward direction for printing stabilizers and components of the 3D object, and controlling movement of the conveyor belt in a reverse direction for rework printing processing.

10. The method of claim 1, further comprises providing a continuous supply of the primary material and the secondary material to enable continuous printing of stabilizers and components of the 3D object without interruption.

11. A system, comprising:
a processor; and
a memory, wherein the memory includes a computer program product configured to perform operations for implementing continuous 3D printing to manufacture a 3D object, the operations comprising:
selecting a 3D object to be printed in components along a conveyor belt from a primary material;
printing a first stabilizer from a secondary material having a shape based on a first component of the 3D object;
printing the first component on the first stabilizer;
printing a second stabilizer from the secondary material connected to the first stabilizer having a shape based on a second component of the 3D object;
printing the second component on the second stabilizer;
identifying completion of printing all the components of the 3D object; and
removing the 3D object with the stabilizers from the conveyor belt.

12. The system of claim 11, further comprising:
removing the 3D object from the stabilizers following removal of the 3D object and the stabilizers from the conveyor belt.

13. The system of claim 11, wherein identifying completion of printing all the components of the 3D object further comprises printing a connecting stabilizer from the secondary material connected to the stabilizers, and wherein the connecting stabilizer is cut to separate the removed 3D object from a next 3D object to be printed.

14. The system of claim 11, wherein identifying completion of printing all the components of the 3D object further comprises cleaning the conveyor belt with a decontaminator positioned under the conveyor belt.

15. The system of claim 11, further comprises providing a continuous supply of the primary material and the secondary material to enable continuous printing of stabilizers and components of the 3D object without interruption.

16. A computer program product for implementing continuous 3D printing to manufacture a 3D object, the computer program product comprising:
a computer-readable storage medium having computer-readable program code embodied therewith, the computer-readable program code executable by one or more computer processors to perform an operation comprising:
selecting a 3D object to be printed in components along a conveyor belt from a primary material;
printing a first stabilizer from a secondary material having a shape based on a first component of the 3D object;
printing the first component on the first stabilizer;
printing a second stabilizer from the secondary material connected to the first stabilizer having a shape based on a second component of the 3D object;
printing the second component on the second stabilizer;
identifying completion of printing all the components of the 3D object; and
removing the 3D object with the stabilizers from the conveyor belt.

17. The computer program product of claim 16, wherein the computer-readable program code is further executable to perform an operation comprising;
removing the 3D object from the stabilizers following removal of the 3D object and the stabilizers from the conveyor belt.

18. The computer program product of claim 16, wherein identifying completion of printing all the components of the 3D object further comprises printing a connecting stabilizer from the secondary material connected to the stabilizers, and wherein the connecting stabilizer is cut to separate the removed 3D object from a next 3D object to be printed.

19. The computer program product of claim 16, wherein identifying completion of printing all the components of the 3D object further comprises cleaning the conveyor belt with a decontaminator positioned under the conveyor belt.

20. The computer program product of claim 16, further comprises providing a continuous supply of the primary material and the secondary material to enable continuous printing of stabilizers and components of the 3D object without interruption.
